(19) United States
(12) Patent Application Publication
(10) Pub. No.: US 2024/0364500 A1
(43) Pub. Date: Oct. 31, 2024

(54) SYSTEMS AND METHODS FOR AUTHENTICATING VIDEO FEEDS

(71) Applicant: CenturyLink Intellectual Property LLC, Denver, CO (US)

(72) Inventors: Dean Ballew, Sterling, VA (US); John R.B. Woodworth, Amissville, VA (US)

(73) Assignee: CenturyLink Intellectual Property LLC, Denver, CO (US)

(21) Appl. No.: 18/630,595

(22) Filed: Apr. 9, 2024

Related U.S. Application Data
(60) Provisional application No. 63/498,955, filed on Apr. 28, 2023.

(51) Int. Cl. H04L 9/06; H04L 9/32; H04N 23/11; H04N 23/56; H04N 23/695

(52) U.S. Cl. CPC H04L 9/065; H04L 9/32; H04N 23/11; H04N 23/56; H04N 23/695

(57) ABSTRACT

Video cameras are used for monitoring, e.g., for security, in various applications, such as monitoring property, or ingress or egress points from buildings. Such video cameras may be vulnerable to various kinds of attack, which may seek to interfere with the capturing of a video stream by the camera, or with the subsequent transmission of the video stream. As such, systems and methods for authenticating video feeds are provided.

### CROSS-REFERENCE TO RELATED APPLICATIONS

This application claims the benefit of U.S. Provisional Application No. 63/498,955 filed Apr. 28, 2023, entitled “Systems and Methods for Authenticating Video Feeds,” which is incorporated herein by reference in its entirety.

### FIELD

One or more aspects according to the present disclosure relate to the capturing and transmission of video signals, and more particularly to systems and methods for authenticating video feeds.

### BACKGROUND

Video cameras are used for monitoring, e.g., for security, in various applications, such as monitoring property, or ingress or egress points from buildings. Such video cameras may be vulnerable to various kinds of attack, which may seek to interfere with the capturing of a video stream by the camera, or with the subsequent transmission of the video stream.

It is with respect to this general technical environment that aspects of the present disclosure are related. While relatively specific examples have been discussed, it should be understood that aspects of the present disclosure should not be limited to solving the specific examples identified in the background.

### SUMMARY

Systems and methods for authenticating video feeds are provided. In an aspect, a system includes a first projector and a first analyzer circuit. The first projector may be configured to form an illuminated pattern within a first field of view of a video camera, and the first analyzer circuit may be configured to determine whether the illuminated pattern is present in a video stream produced by the video camera.

In examples, the first projector is configured to project the illuminated pattern onto a surface in the first field of view of the video camera.

In examples, the first projector is in the first field of view of the video camera and is configured to illuminate the video camera directly.

In examples, the system further comprises the video camera, wherein the video camera is configured to capture the illuminated pattern within the first field of view, and the first analyzer circuit is configured to produce a cropped video stream comprising a cropped field of view excluding the illuminated pattern.

In examples, the illuminated pattern in a plurality of frames of the video stream represents an encrypted signal.

In examples, the illuminated pattern represents, in one frame of the video stream, an encrypted signal.

In examples, the illuminated pattern represents an encrypted indication of a time at which the illuminated pattern was formed.

In examples, the system further comprises a reflector, configured to reflect light from the first projector to the video camera.

In examples, the video camera is configured to send the video stream to the first analyzer circuit in encrypted form.

In examples, the first analyzer circuit is configured to produce an encrypted video stream.

In examples, the system is configured to pan the video camera to capture the first field of view and a second field of view within a scene. In further examples, the first projector is configured to form a first illuminated pattern in the first field of view and to form a second illuminated pattern in the second field of view. In further examples, the system further comprises a second projector, wherein: the first projector is configured to form an illuminated pattern within the first field of view of the video camera, and the second projector is configured to form an illuminated pattern within the second field of view of the video camera.

In examples, the video camera is capable of detecting infrared light, and the first projector is configured to emit infrared light.

In examples, the analyzer is configured, in response to determining that the illuminated pattern is not present in a video stream, to take a mitigation action.

In another aspect, a method is presented, comprising: forming, by a projector, a first illuminated pattern in a scene, and authenticating, by an analyzer circuit, a video stream of a portion of the scene, the authenticating comprising determining that the first illuminated pattern is present in the video stream. In examples, the authenticating comprises verifying an encrypted value encoded in the first illuminated pattern.

In another aspect, a system is presented that includes a processing circuit; and memory, operatively connected to the processing circuit and storing instructions that, when executed by the processing circuit, cause the system to perform a method. In examples, the method comprises: receiving a video stream from a camera, the video stream including an illuminated pattern captured by the camera; decoding an illuminated pattern in the video stream to obtain a numerical value; and authenticating the video stream based on the numerical value. In examples, the numerical value is an encrypted value. In examples, the method further comprises producing an encrypted video stream.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

These and other features and advantages of the present disclosure will be appreciated and understood with reference to the specification, claims, and appended drawings. Non-limiting and non-exhaustive examples are described with reference to the following figures:

FIG. 1A is a schematic drawing of a video security system, according to an example of the present disclosure;

FIG. 1B is a block diagram of an analyzer, according to an example of the present disclosure;

FIG. 2 is a flow chart, according to an example of the present disclosure; and

FIG. 3 is a block diagram of an operating environment, according to an example of the present disclosure.

### DETAILED DESCRIPTION

The following detailed description illustrates a few exemplary embodiments in further detail to enable one of skill in the art to practice such examples. The described examples are provided for illustrative purposes and are not intended to limit the scope of the invention.

In the following description, for the purposes of explanation, numerous specific details are set forth in order to provide a thorough understanding of the described examples. It will be apparent to one skilled in the art, however, that other examples of the present invention may be practiced without some of these specific details. In other instances, certain structures and devices are shown in block diagram form. Several examples are described herein, and while various features are ascribed to different examples, it should be appreciated that the features described with respect to one example may be incorporated with other examples as well. By the same token, however, no single feature or features of any described example should be considered essential to every example of the invention, as other examples may omit such features.

Unless otherwise indicated, all numbers used herein to express quantities, dimensions, and so forth used should be understood as being modified in all instances by the term “about.” In this application, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components comprising one unit and elements and components that comprise more than one unit, unless specifically stated otherwise.

Video systems may be used in various monitoring applications, e.g., for security. For example, security cameras may monitor potential entrances to buildings or other (e.g., fenced) enclosures, or they may monitor assets such as vehicles, outdoor equipment, indoor equipment (e.g., equipment in a server room), or routes (e.g., hallways in schools, hospitals, or prisons) on which only authorized personnel should be present. Such video systems, depending on their design, may be vulnerable to various types of attack. For example, an attacker may defeat a camera monitoring a hallway by placing a photograph of the hallway in front of the camera (or a display playing a loop of previously obtained video of the hallway), thereby preventing the camera from recording the true contents of the scene to be monitored while preventing or delaying the discovery (e.g., by security personnel or an automated security program, monitoring the video captured by the camera) of the deception.

Other attacks may involve, for example, tapping into a communications link between a video camera and a display (e.g., a display used by security personnel) and transmitting, to the display (instead of the live video stream ordinarily transmitted to the display), a loop of previously obtained video, or a video stream consisting of a single repeated frame, the frame having been obtained, for example, from the video stream previously received from the video camera. Yet another attack may involve gaining control of the camera, e.g., by exploiting a vulnerability of the camera to upload to the camera software or firmware created by the attacker. Such software or firmware may then (i) record video from the camera during some interval of time, and (ii) transmit the video repeatedly, in a loop, from the camera, thereby disabling the camera without the loss of function being immediately obvious to human or automated monitors observing or processing the video from the camera.

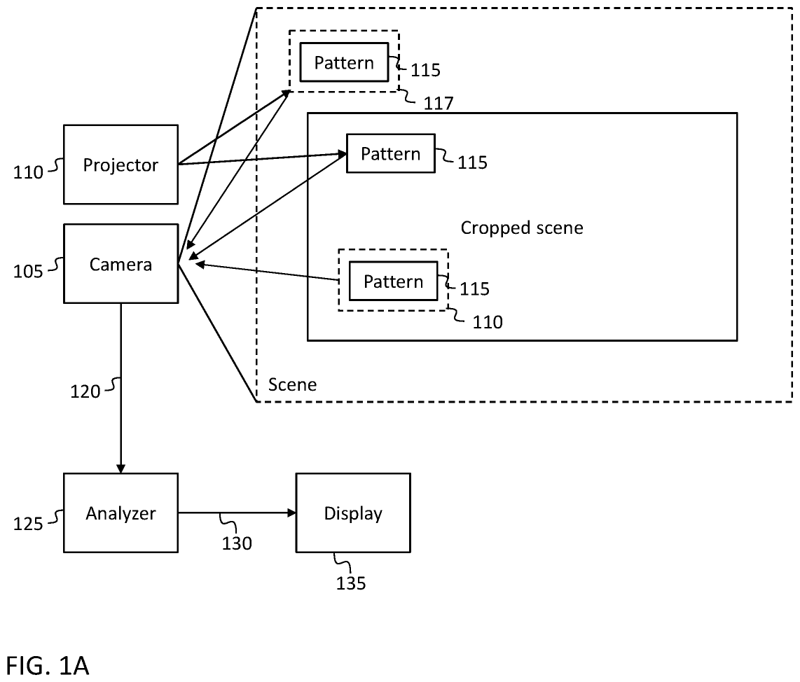

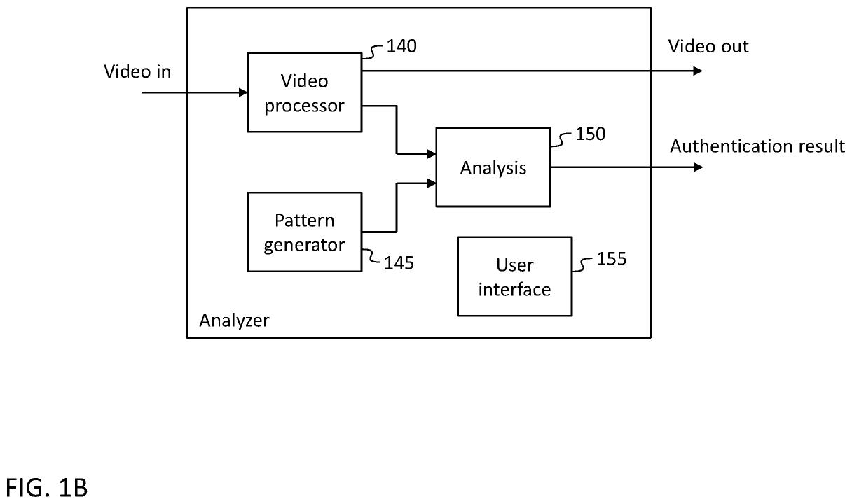

In some examples, therefore, an illuminated pattern in the scene may be used to authenticate video recorded by the camera. Referring to FIG. 1, a video camera 105 may record video of a scene. The scene may comprise a physical environment. For example, the scene may include, e.g., an exterior view of a door of a building, a portion of the ground in front of the door, and a portion of the wall within which the door is set, among other examples. In examples, the projector 110 comprises one or more light source(s) and circuitry to control whether some or all of the light source(s) of the projector 110 are turned on or off and/or to vary the intensity of the light source. In examples, the projector 110 may also include a controllable (manually or automatically) lens, mirrors, or other elements configured to permit the projector 110 to project an illuminated pattern. A projector 110 may project an illuminated pattern 115 onto a surface in the scene, e.g., onto the door or onto the wall at a point adjacent to, or above, the door. The light from the illuminated pattern 115 may be reflected back to video camera 105. In other examples, the projector 110 may project an illuminated pattern directly towards the video camera 105. The illuminated pattern 115 may be captured by the video camera 105, and the video stream from the video camera 105 may be transmitted through a first video link 120 to an analyzer (e.g., an analyzer circuit) 125, which may (as discussed in further detail below) determine whether the illuminated pattern 115 is present in the video stream received from the video camera 105, and which may transmit the video stream, or a portion of the video stream, via a second video link 130, to a display 135.

In some examples, as discussed in further detail below, (a) both the analyzer and the projector receive the same seed value (e.g., synchronized current time); (b) the projector encodes the seed value; (c) the projector projects a pattern representing the encoded seed value; (d) the camera captures a portion of the scene, including the pattern, and sends the corresponding video stream; (e) the analyzer determines the illuminated pattern from the received video stream and extracts the encoded seed value from the video stream; and (f) the analyzer decodes the received, encoded seed value to determine whether the expected pattern (representing the seed value) was received.

The illuminated pattern 115 may have a brightness that varies with time, or with time and position. For example, an illuminated pattern may consist of a single spot in the scene that is at sometimes bright and at sometimes dark. In some examples, the illuminated pattern 115 may be projected from outside the scene into the field of view of the camera 105. In other examples, the illuminated pattern 115 may be illuminated by light source(s) that are within the scene itself (e.g., one or more light-emitting diode (LED) on projector 110 placed within the scene, wherein the LED(s) is/are turned on or off to project the pattern). Such a pattern may encode a numerical value, e.g., using on-off modulation. As another example, an illuminated pattern may include a sequence of spatial patterns, each of which may, at a single point in time, encode a respective numerical value, e.g., each spatial pattern may consist of a pattern of bright and dark regions (e.g., bright and dark squares), the bright and dark regions encoding the numerical value. The numerical value encoded in any of the spatial patterns may be, for example, the respective current time of day. As another example, the numerical value may be a value that changes in a predictable manner with time (e.g., a value that increases monotonically, or follows a pseudorandom sequence, or such a value, encrypted for authentication (as discussed in further detail below)) and that can be generated in the analyzer 125, so that the analyzer 125 may determine whether an encoded value in a video stream is equal to a value that is expected to be present, at any given time. As used herein, “encoding” means converting a numerical value (e.g., a time of day) into a pattern, such as a pattern of bright and dark regions; “decoding” means recovering the numerical value from an encoded signal.

If an attack involves (i) placing a still image (e.g., a photograph or a display showing an unchanging image of the scene) in front of the camera, or (ii) tapping into the first video link 120 and substituting, for the live video stream, a video stream consisting of a single repeated frame, then the attack may be detected from the absence of the changing illuminated pattern 115. As such, the analyzer 125 may include or be a circuit that (i) finds the illuminated pattern 115 in the video stream, and (ii) determines whether the illuminated pattern 115 is the illuminated pattern 115 that is currently being formed by the projector 110, or (to allow for small delays between capture of video images by the video camera 105 and transmission of the video images to the analyzer 125) that was recently formed by the projector 110. If the analyzer 125 determines that a correct illuminated pattern 115 is present in the video stream, it may transmit the video stream to the display 135. In some examples, the video stream is cropped, e.g., by the analyzer 125 or by the display 135, so that the illuminated pattern 115 (which may be present, e.g., near an edge of the frames of video) is removed, and not displayed by the display 135, e.g., to avoid distracting viewers of the video. In examples, cropping out the illuminated pattern 115 by the analyzer 125 prior to the video stream being provided to the display 135 may also further secure the system against attackers who have access only to the video stream at second video link 130 and would then be unaware of the presence of the illuminated pattern 115 in the video stream.

Both the projector 110 and the analyzer 125 may be in possession of information sufficient to determine which illuminated pattern 115 should be formed at any time, so that (i) the projector 110 may form the correct illuminated pattern 115 and (ii) the analyzer may be capable of determining whether the illuminated pattern 115 in the video stream is correct. This may be accomplished in several ways. For example, (i) the projector 110 may have a communications link (e.g., a bidirectional communications link) with the analyzer 125, and the analyzer 125 may provide instructions to the projector 110 regarding the illuminated pattern 115 to be generated, or (ii) the projector 110 and the analyzer may be synchronized or otherwise programmed so that the analyzer 125 is aware of what pattern the projector 110 should be projecting. For example, both the analyzer 125 and the projector 110 may be using a synchronized clock time and both may be programmed with an algorithm to translate whatever that time is into a corresponding illuminated pattern 115 (or, in the case of the analyzer 125, to decode the pattern into a clock time and determine if the decoded time matches the the synchronized clock time).

If the projector 110 and the analyzer 125 are connected by a bidirectional communications link, then the analyzer 125 may also periodically query the health status of the projector 110 and, if the analyzer 125 does not detect the correct illuminated pattern 115 in the video stream, it may alert the user that (i) the projector is operating normally but the pattern is not detected, or that (ii) the projector is no longer operating (which may be a sign of wrongdoing, or may be a sign of a mechanical failure). In very high security situations, the system may include two projectors 110 and two illuminated patterns 115 that are detected (to account for the possibility that one projector may innocently fail).

The analyzer 125 may use any of several methods to find the illuminated pattern. In some situations, the illuminated pattern may be the brightest portion of the scene, so that a set of instructions executed by a processing circuit of the analyzer 125 may find the illuminated pattern 115 by, e.g., finding a rectangular region of a certain size within an image of the video stream within which the mean intensity is, e.g., at least five times greater than the mean intensity within the image.

In some nonexclusive examples, a neural network may be trained to find the illuminated pattern 115, using labeled training data consisting of various images upon which has been digitally superimposed an example of the illuminated pattern 115; each such training image may be labeled with the location (e.g., the coordinates) of the illuminated pattern 115 in the image. For such training, the cost function may be, e.g., the distance between the location of the illuminated pattern 115 as estimated by the neural network and the location with which the image is labeled. In some examples, the analyzer 125 may be programmed with the location of the illuminated pattern 115 in the image, e.g., by an operator setting up the video camera 105 and the projector 110. Other artificial intelligence architectures are possible and contemplated, including but not limited to random forests, support vector machines, k-nearest neighbors algorithms, symbolic regression, or other techniques for identifying and extracting an illuminated pattern 115 that has been projected into a scene.

If the analyzer 125 determines that the illuminated pattern 115 is absent or incorrect, then it may take any of various mitigation actions, e.g., to warn security personnel and/or an automated security system that the video stream is not trustworthy or that an attack may be in progress. For example, it may transmit to the display 135 a video stream showing text with warnings for security personnel monitoring the display; such text may warn the viewers that the trusted video link appears to have been compromised and that an attack on the security system (and on the property or location being monitored) may be in progress. The analyzer 125 may also, e.g., in situations in which video ordinarily is not monitored in real time but instead recorded for possible future viewing, send an alarm to a user, to security personnel, to an automated security service, and/or to a public safety organization (e.g., police), e.g., via email or Short Message Service (SMS).

It may be that an attacker is capable of creating a simulated video stream consisting of (i) video frames each showing a still image of the scene, and (ii) electronically superimposed on these video frames an electronically generated image of the illuminated pattern 115. As an obstacle to such an attack, the illuminated pattern 115 may represent an encrypted signal, such as an encrypted indication of the time at which the illuminated pattern 115 was formed. As used herein, “encrypting” means transforming a first numerical value into an encrypted numerical value, for cryptographic authentication. As such, in one example, a digitally signed numerical value is an encrypted numerical value, as the term “encrypted” is used herein. The encrypting may be performed using a private key, and (if the decrypting uses a different key) the decrypting may be done using a private key or using a public key.

The analyzer 125 may be in any of various locations in the system. For example, it may be in a physically separate location from both the video camera 105 and the display 135 (e.g., in a server room). If the analyzer 125 is physically separated from the display 135 and if the second video link 130 is not deemed secure, then communications transmitted from the analyzer 125 to the display 135 may be signed or otherwise encrypted (with a private key) so that the display may be able to authenticate (using cryptographic authentication) any such communications it receives. If the second video link 130 is deemed secure, e.g., if the analyzer 125 and the display 135 are combined in a single device or both are within secured areas controlled by an operator, then it may not be necessary for the display to authenticate communications received from the analyzer 125 using cryptographic authentication.

Communications transmitted from the video camera 105 to the analyzer 125 may similarly be authenticated, by the analyzer 125, using cryptographic authentication. In some examples, in which the illuminated pattern 115 is encrypted, such authentication may be unnecessary, however, because the presence of the encrypted illuminated pattern 115 may be sufficient to authenticate the communications received by the analyzer 125.

In some examples, the analyzer 125 is distributed, e.g., its features are not all implemented in one location. For example, a circuit for finding the illuminated pattern 115 in each frame of video may be implemented in the video camera 105 (or a combined system or device that includes the video camera 105), and a circuit for decoding and verifying the time signal encoded within the illuminated pattern 115 may be implemented in the display 135 (or a combined system or device that includes the display 135). The verifying of the encoded signal may involve, e.g., (i) decrypting, or attempting to decrypt, the encoded signal, to determine whether it was encrypted with the correct private key, or (ii) encrypting an expected numerical value and comparing the result of the encrypting to the encoded signal. In some examples, the system includes a plurality of analyzers 125, with, e.g., each analyzer being connected to, and feeding a video signal to, a respective one of a plurality of displays 135. The projector 110 may then project the illuminated pattern representing the encrypted time signal.

FIG. 1A depicts several examples of projection of a pattern 115 captured by the camera 105. For example, the projector 110 may form the illuminated pattern 115, using, for example, any suitable projection technology to project each illuminated pattern 115 onto a sufficiently reflective surface (e.g., a wall within the scene, or a reflector 117 placed in the scene for this purpose, such as a mirror or other reflective surface). For example, the projector 110 may include a laser and one or more scanning mirrors, or a suitable light source spatially and temporally modulated by a digital micromirror device. In some other examples, the projector 110 is, itself, in the scene (e.g., hung from a wall in a location that is within the field of view of the video camera 105) and it illuminates the video camera 105 directly instead of illuminating a reflective surface from which light reflects into the video camera 105. For example, the projector 110 may include an array of light-emitting diodes (LEDs), or a display, that is installed within the field of view of the video camera 105.

In some examples, machine learning (ML) or artificial intelligence (AI) may be employed to identify a suitable location, in the scene, for the illuminated pattern 115. For example, a scene may include walls that are not oriented so as to produce an acceptable reflection from the projector 110 (e.g., the walls may not be sufficiently nearly perpendicular to the viewing direction of the video camera 105), or some parts of a wall may be unsuitable because, for example, persons walking in the scene may periodically block the projected illuminated pattern 115 or block the video camera's view of the illuminated pattern 115. As mentioned above, in some examples, the projector 110 has a bidirectional communications link with the analyzer 125. In such an example, the projector 110 may illuminate various candidate locations in the scene and the analyzer 125 may provide feedback to the projector 110 regarding the relative suitability of each of the candidate locations (e.g., based on the ease, as assessed by the analyzer 125, of finding and decoding the illuminated pattern 115 in the video stream). In some examples, the camera is mounted on a gimbal and may pan back and forth across the scene, so that at one point in time it may capture a first field of view and at a second point in time it may capture a second field of view. In such an example, the projector 110 may scan with the camera (e.g., being mounted on the same gimbal or on a separate gimbal), or the projector 110 may aim, in turn, at several different locations in the scene, or a plurality of projectors 110, each aimed at a different respective position in the scene may be employed, so that (i) the illuminated pattern 115 is always in the same location of the video captured by the video camera 105 (e.g., relative to a corner of the field of view) or so that (ii) the illuminated pattern 115 is always in the video captured by the video camera 105 (at different locations, which may be subsequently identified by the analyzer 125).

In some examples, the light produced by the projector 110 is infrared (IR) light, and the video camera 105 is configured (e.g., by the absence of an IR-blocking filter) to be sensitive to IR light. In such an example, the illuminated pattern 115 may not be apparent to a human viewing the scene directly, and, as such, an attacker may be unaware of the presence of illuminated pattern 115 as an obstacle to an attack. Moreover, the distraction that the illuminated pattern 115 might generate for other persons in the scene may be avoided by using IR light.

In some examples the projector 110 is not a source of light but instead modulates light reflected from it or transmitted through it to form the illuminated pattern 115. For example, the projector 110 may include a disk on a motor, the disk having a white front surface and a black back surface, the motor being driven by a circuit causing the white and black surfaces to be displayed in a pattern encoding the current time (or an encrypted signal, the encrypted signal being the result of encrypting the current time). In another example, the projector 110 includes a spatial light modulator (e.g., modulating light from a dedicated source of light or modulating ambient light in the scene).

FIG. 1B is a block diagram of an analyzer 125, in some examples. The analyzer includes a video processor 140 (e.g., for extracting the illuminated pattern 115 from the video and for generating a cropped video (which may be sent to the video output) from which the illuminated pattern 115 has been removed), a pattern generator 145 (which may generate a reference pattern to which the illuminated pattern 115 in the received video may be compared), an analysis circuit 150 (which may attempt to authenticate the received video, based on the illuminated pattern 115 it contains), and a user interface 155 (which may be employed by a user to configure the system).

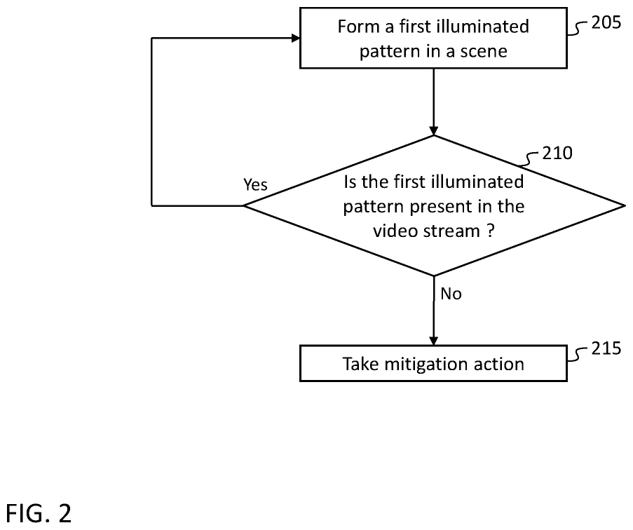

FIG. 2 is a flowchart of a method, in some examples. The method includes forming, at 205, by a projector, a first illuminated pattern in a scene. As discussed, this may be accomplished, e.g., by a projector either projecting light into a scene or by the projector being located within the scene. The first illuminated pattern may encode a value (e.g., a clock time) that can be replicated by an analyzer. As such, at operation 210, an analyzer circuit may determine whether the expected first illuminated pattern is present in a video stream of a portion of the scene. In examples, the analyzer is able to decode an illuminated pattern discovered in the video stream to determine if it is representative of the expected value (e.g., the clock time). If, at 210, it is determined that the first illuminated pattern is present in the video stream, control returns to operation 205. In examples, the first illuminated pattern may change at various points in time during the operations 205 and 210 (e.g., if the illuminated pattern is indicative of a changing clock time, for example). As such, the forming of the illuminated pattern and determining of whether the expected illuminated pattern is present in the video stream is repeated as long as the expected illuminated pattern is present in the video stream. If, at 210, it is determined that the first illuminated pattern is not present in the video stream, then a mitigation action (e.g., as described above), is taken at 215.

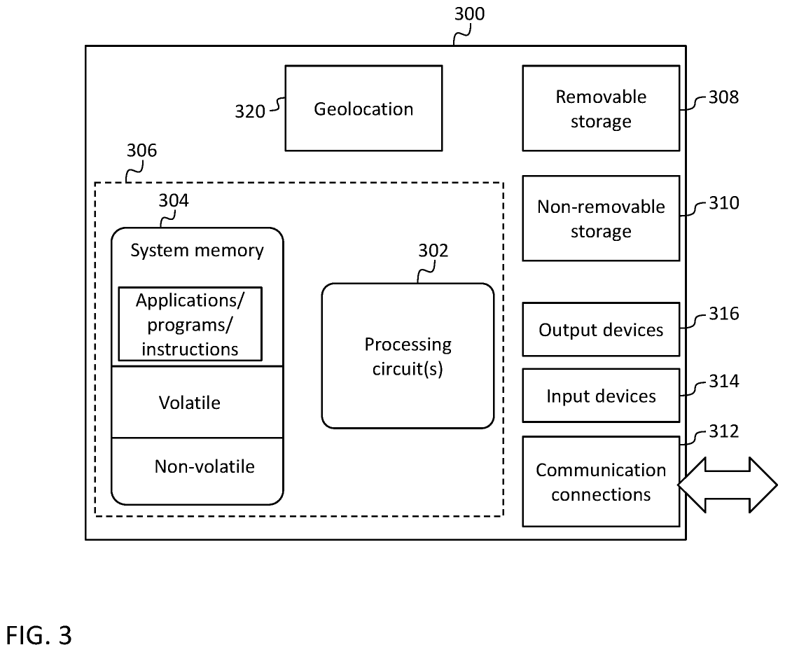

FIG. 3 depicts an example of a suitable operating environment 300, portions of which may be used to implement the video camera 105, the projector 110, the analyzer 125, the display 135, or other devices that may include computing functionality within the systems discussed herein. In its most basic configuration, operating environment 300 typically includes at least one processing circuit 302 and memory 304. The processing circuit may be a processor, which is hardware. Depending on the exact configuration and type of computing device, memory 304 (storing instructions to perform the methods disclosed herein) may be volatile (such as RAM), non-volatile (such as ROM, flash memory, etc.), or some combination of the two. This most basic configuration is illustrated in FIG. 3 by dashed line 306. The memory 304 stores instructions that, when executed by the processing circuit(s) 302, perform the processes and operations described herein. Further, environment 300 may also include storage (removable 308, or non-removable 310) including, but not limited to, solid-state, magnetic disks, optical disks, or tape. Similarly, environment 300 may also have input device(s) 314 such as keyboard, mouse, pen, voice input, etc., or output device(s) 316 such as a display, speakers, printer, etc. Additional communication connections 312 may also be included that allow for further communication with LAN, WAN, point-to-point, etc. Operating environment 300 may also include geolocation devices 320, such as a global positioning system (GPS) device.

Operating environment 300 typically includes at least some form of computer readable media. Computer readable media can be any available media that can be accessed by processing circuit 302 or other devices comprising the operating environment. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory medium which can be used to store the desired information. Computer storage media is non-transitory and does not include communication media.

Communication media embodies computer readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, microwave, and other wireless media. Combinations of any of the above should also be included within the scope of computer readable media.

The term “processing circuit” is used herein to mean any combination of hardware, firmware, and software, employed to process data or digital signals. Processing circuit hardware may include, for example, application specific integrated circuits (ASICs), general purpose or special purpose central processing units (CPUs), digital signal processors (DSPs), graphics processing units (GPUs), and programmable logic devices such as field programmable gate arrays (FPGAs). In a processing circuit, as used herein, each function is performed either by hardware configured, i.e., hard-wired, to perform that function, or by more general-purpose hardware, such as a CPU, configured to execute instructions stored in a non-transitory storage medium. A processing circuit may be fabricated on a single printed circuit board (PCB) or distributed over several interconnected PCBs. A processing circuit may contain other processing circuits; for example, a processing circuit may include two processing circuits, an FPGA and a CPU, interconnected on a PCB.

While certain features and aspects have been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods provided by various examples are not limited to any particular structural and/or functional architecture but instead can be implemented on any suitable hardware, firmware and/or software configuration. Similarly, while certain functionality is ascribed to certain system components, unless the context dictates otherwise, this functionality can be distributed among various other system components in accordance with the several examples.

Moreover, while the procedures of the methods and processes described herein are described in a particular order for ease of description, unless the context dictates otherwise, various procedures may be reordered, added, and/or omitted in accordance with various examples. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various examples are described with—or without—certain features for ease of description and to illustrate exemplary aspects of those examples, the various components and/or features described herein with respect to a particular example can be substituted, added and/or subtracted from among other described examples, unless the context dictates otherwise. Consequently, although several exemplary embodiments are described above, it will be appreciated that the invention is intended to cover all modifications and equivalents within the scope of the following claims.

What is claimed is:

1. A system, comprising:
a first projector; and
a first analyzer circuit,
the first projector being configured to form an illuminated pattern within a first field of view of a video camera,
the first analyzer circuit being configured to determine whether the illuminated pattern is present in a video stream produced by the video camera.

2. The system of claim 1, wherein the first projector is configured to project the illuminated pattern onto a surface in the first field of view of the video camera.

3. The system of claim 1, wherein the first projector is in the first field of view of the video camera and is configured to illuminate the video camera directly.

4. The system of claim 1, further comprising the video camera, wherein the video camera is configured to capture the illuminated pattern within the first field of view, and the first analyzer circuit is configured to produce a cropped video stream comprising a cropped field of view excluding the illuminated pattern.

5. The system of claim 1, wherein the illuminated pattern in a plurality of frames of the video stream represents an encrypted signal.

6. The system of claim 1, wherein the illuminated pattern represents, in one frame of the video stream, an encrypted signal.

7. The system of claim 1, wherein the illuminated pattern represents an encrypted indication of a time at which the illuminated pattern was formed.

8. The system of claim 1, further comprising a reflector, configured to reflect light from the first projector to the video camera.

9. The system of claim 1, wherein the video camera is configured to send the video stream to the first analyzer circuit in encrypted form.

10. The system of claim 1, wherein the first analyzer circuit is configured to produce an encrypted video stream.

11. The system of claim 1, wherein the system is configured to pan the video camera to capture the first field of view and a second field of view within a scene.

12. The system of claim 11, wherein the first projector is configured to form a first illuminated pattern in the first field of view and to form a second illuminated pattern in the second field of view.

13. The system of claim 11, further comprising a second projector, wherein:
the first projector is configured to form an illuminated pattern within the first field of view of the video camera, and
the second projector is configured to form an illuminated pattern within the second field of view of the video camera.

14. The system of claim 1, wherein the video camera is capable of detecting infrared light, and the first projector is configured to emit infrared light.

15. The system of claim 1, wherein the analyzer is configured, in response to determining that the illuminated pattern is not present in a video stream, to take a mitigation action.

16. A method, comprising:
forming, by a projector, a first illuminated pattern in a scene, and
authenticating, by an analyzer circuit, a video stream of a portion of the scene, the authenticating comprising determining that the first illuminated pattern is present in the video stream.

17. The method of claim 16, wherein the authenticating comprises verifying an encrypted value encoded in the first illuminated pattern.

18. A system, comprising:
a processing circuit; and
memory, operatively connected to the processing circuit and storing instructions that, when executed by the processing circuit, cause the system to perform a method, the method comprising:
receiving a video stream from a camera, the video stream including an illuminated pattern captured by the camera;
decoding an illuminated pattern in the video stream to obtain a numerical value, and
authenticating the video stream based on the numerical value.

19. The system of claim 18, wherein the numerical value is an encrypted value.

20. The system of claim 18, wherein the method further comprises producing an encrypted video stream.
